(19) United States
(12) Patent Application Publication
(10) Pub. No.: US 2026/0110940 A1
(43) Pub. Date: Apr. 23, 2026

(54) DISPLAY MODULE AND DISPLAY DEVICE

(71) Applicant: Guangzhou China Star Optoelectronics Semiconductor Display Technology Co., Ltd., Guangzhou (CN)

(72) Inventors: Yoonsung UM, Guangzhou (CN); Yanjun SONG, Guangzhou (CN); Fan YANG, Guangzhou (CN)

(73) Assignee: Guangzhou China Star Optoelectronics Semiconductor Display Technology Co., Ltd., Guangzhou (CN)

(21) Appl. No.: 19/023,661

(22) Filed: Jan. 16, 2025

(30) Foreign Application Priority Data
Oct. 22, 2024 (CN) 202411479444.8

(51) Int. Cl. G02F 1/1362; G02F 1/1335

(52) U.S. Cl. CPC G02F 1/136209; G02F 1/133528; G02F 1/136222; G02F 1/136286; G02F 2201/50

(57) ABSTRACT

A display module and a display device are provided. The display module includes a display panel and a first polarizer disposed on one side of the display panel away from the display module, and the display panel includes a first substrate, a light-shielding layer along with a plurality of date lines and a plurality of scan lines located at the first substrate, and an orthographic projection of the plurality of data lines and the plurality of scan lines on the first substrate is located within an orthographic projection of the light-shielding layer on the first substrate, and a light adjustment structure is disposed on the first polarizer, and the light adjustment structure is corresponded to the light-shielding layer; and the display module has a photic zone and a non-photic zone.

### CROSS-REFERENCE TO RELATED APPLICATION

The application claims priority to and the benefit of Chinese Patent Application No. 202411479444.8, filed on Oct. 22, 2024, the disclosure of which is incorporated herein by reference in its entirety.

### TECHNICAL FIELD

The present application relates to the field of display technologies, and in particular, to a display module and a display device.

### BACKGROUND

The Liquid Crystal Display modules (LCD) are widely used in various electronic devices such as mobile phones, digital cameras, computer screens, or laptop screen.

In current liquid crystal display devices, the transmittance of the display device is typically enhanced by increasing the aperture ratio of the array substrate; however, due to the more complex metal wiring in the array substrate, the aperture ratio of the array substrate cannot be further increased, thus limiting the improvement of transmittance in current display devices.

### SUMMARY

The present application provides a display module and a display device, aimed at improving the technical issue of low transmittance in existing display modules.

To address the aforementioned issues, the technical scheme provided by the present application is as follows:

The embodiments of the present application provide a display module, wherein the display module includes:

a display panel, including a first substrate, a light-shielding layer along with a plurality of date lines and a plurality of scan lines located at the first substrate, and orthographic projections of the plurality of data lines and the plurality of scan lines on the first substrate is located within an orthographic projection of the light-shielding layer on the first substrate; and

a first polarizer, disposed on one side of the display panel away from a light-exiting surface of the display module, wherein a light adjustment structure is disposed on the first polarizer, and the light adjustment structure corresponds to the light-shielding layer;

wherein an orthographic projection of the light adjustment structure on the first substrate partially overlaps an orthographic projection of the light-shielding layer on the first substrate.

In a second aspect, the present application provides a display device, and the display device includes the display module, the display module includes:

a display panel, including a first substrate, a light-shielding layer along with a plurality of date lines and a plurality of scan lines located at the first substrate, and orthographic projections of the plurality of data lines and the plurality of scan lines on the first substrate is located within an orthographic projection of the light-shielding layer on the first substrate; and

a first polarizer, disposed on one side of the display panel away from a light-exiting surface of the display module, wherein a light adjustment structure is disposed on the first polarizer, and the light adjustment structure corresponds to the light-shielding layer;

wherein an orthographic projection of the light adjustment structure on the first substrate partially overlaps an orthographic projection of the light-shielding layer on the first substrate.

### BRIEF DESCRIPTION OF THE DRAWINGS

To provide a clearer explanation of the technical proposals presented in the embodiments of the present application, a brief introduction to the drawings required for the description of the embodiments is provided below. It is evident that the drawings described below are merely some embodiments of the present application. For those skilled in the art, other drawings can also be derived from these drawings without creative efforts.

To more fully understand the present application and beneficial effects of the present application, the following description is provided along with the accompanying drawings, wherein like reference numerals in the description denote like parts.

FIG. 1 is a schematic diagram of a structure of a display module provided in the embodiment of the present application;

FIG. 2 is a schematic diagram of a first type of film layer in the display panel of the display module provided in the embodiment of the present application;

FIG. 3 is a schematic diagram of a second type of film layer in the display panel of the display module provided in the embodiment of the present application;

FIG. 4 is a schematic diagram illustrating a top view for the display module described in the embodiments of the present application;

FIG. 5 is a structural diagram of a first type of polarizer and color filter layer in a display module provided in an embodiment of the present application;

FIG. 6 is a structural diagram of a first polarizer in the display module provided in the embodiment of the present application;

FIG. 7 is a structural diagram of a second type of first polarizer and color filter layer in the display module provided in the embodiment of the present application;

FIG. 8 is another structural diagram of the first polarizer in the display module in the embodiment of the present application;

FIG. 9 is a cross-sectional view taken along line AA in FIG. 4.

FIG. 10 is a first cross-sectional view taken along line BB in FIG. 4;

FIG. 11 is a second cross-sectional view taken along line BB in FIG. 4;

FIG. 12 is a third cross-sectional view taken along line BB in FIG. 4; and

FIG. 13 is a fourth cross-sectional view taken along line BB in FIG. 4.

List of the reference signs is as follows:

display module 100; display panel 200;

array substrate 210; first substrate 211; array layer 212; gate layer 212a; gate insulating layer 212b; active layer 212c; source-drain layer 212d; passivation layer 212e; pixel electrode layer 212f;

color filter substrate 220; second substrate 221; color resist layer 222; color resist unit 222a; light-shielding layer 223; first light-shielding strip 223a; second light-shielding strip 223b; common electrode layer 224; color filter layer CF;

seal 230;

first polarizer 300; polarizing layer 301; first protective layer 302; adhesive layer 303; second protective layer 304; second polarizer 400;

light adjustment structure 500; groove 510; first sidewall 510a; second sidewall 510b; first groove 511; second groove 512;

spacer layer PS; liquid crystal Layer LC; red color resist R; green color resist G; blue color resist B; data line (Data) and scan line (Scan); first overlapping section OL₁; second overlapping section OL₂.

### DETAILED DESCRIPTION

The technical proposals in the embodiments of the present application will be clearly and completely described according to the accompanying drawings in the embodiments of the present application. The described embodiments are only some of the embodiments of the present application, rather than all the embodiments. Based on the embodiments in the application, all other embodiments obtained by those skilled in the field without making creative efforts fall within the scope of protection of the application.

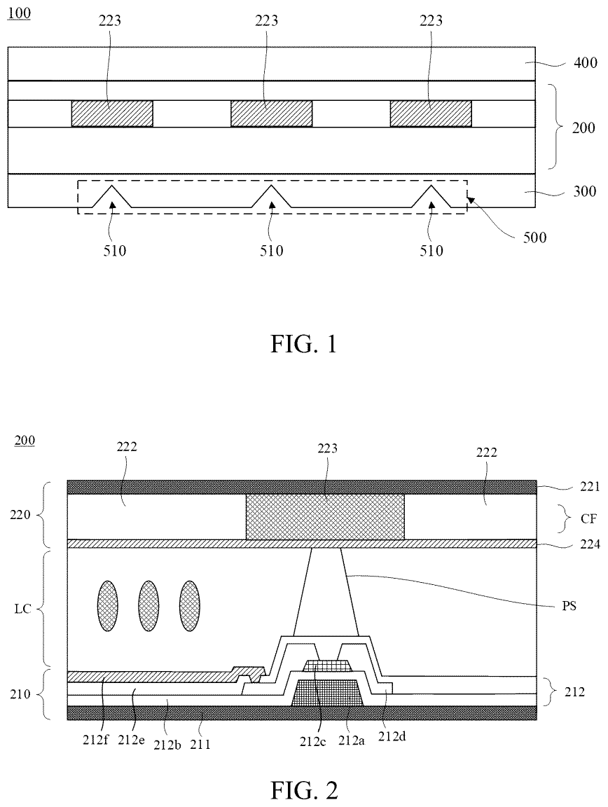

Referring to FIGS. 1 to 13, the present application provides a display module 100, and the display module 100 includes a display panel 200 and a first polarizer 300, and the first polarizer 300 is disposed on one side of the light-exiting surface side of the display panel 200 away from the display module 100.

In the embodiment of the present application, the display panel 200 includes a first substrate 211, a light-shielding layer 223 along with a plurality of date lines Data and a plurality of scan lines Scan located at the first substrate 211, and orthographic projections of the plurality of data lines Data and the plurality of scan lines Scan on the first substrate 211 being located within an orthographic projection of the light-shielding layer 223 on the first substrate 211.

In an embodiment of the present application, a light adjustment structure 500 is arranged on the first polarizer 300, and the light adjustment structure 500 corresponds to the light-shielding layer 223, and the display module 100 has a photic zone TS and a non-photic zone NTS, where the non-photic zone NTS corresponds to the light-shielding layer 223, and the light adjustment structure 500 is configured to direct the light incident on the non-photic zone NTS towards the photic zone TS.

In the current display module 100, due to the complex metal wiring in the array substrate 210, the aperture ratio of the array substrate 210 cannot be further increased, thus limiting the improvement of the transmittance of the display module 100. However, in the present application, by disposing a light adjustment structure 500 corresponding to the light-shielding layer 223 on one side of the first polarizer 300 away from the display surface, the light incident to the non-photic zone NTS is directed towards the photic zone TS. That is, without increasing the aperture ratio of the array substrate 210, the light adjustment structure 500 of the present application can increase the number of light rays incident towards the photic zone TS, thereby improving the transmittance of the display module 100 and further enhancing display effect of the display module 100.

The technical proposal of the present application can be described in conjunction with specific embodiments.

Refer to FIG. 2, the display panel 200 may include an array substrate 210, a color filter substrate 220 disposed on one side of the array substrate 210, and a liquid crystal layer LC disposed between the array substrate 210 and the color filter substrate 220, and the array substrate 210 may be a conventional array substrate 210 or a COA (Color filter On Array, a substrate with a color filter layer disposed on the array), and the present application does not specifically limit a type of the array substrate 210.

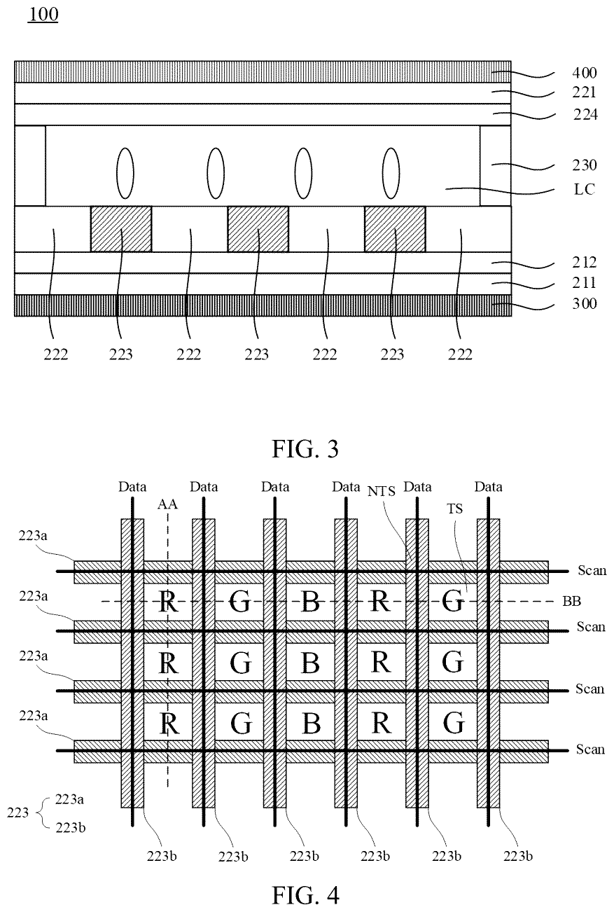

For example, when the array substrate 210 of the present application is a conventional array substrate, the light-shielding layer 223 of the present application can be located at the color filter substrate 220, as shown in the structure of FIG. 2; and when the array substrate 210 of the present application is a COA substrate, the light-shielding layer 223 of the present application can be located at the array substrate 210, as shown in the structure of FIG. 3, and the following embodiments will be described with reference to the structure of FIG. 2.

In this embodiment, the array substrate 210 may include a first substrate 211 and an array layer 212 located at the first substrate 211, the array layer 212 may include a plurality of Thin Film Transistors TFTs. The Thin Film Transistors TFTs may be of the etch stopper barrier type, back channel etch type, alternatively, a structure of a bottom gate thin film transistor or a top gate thin film transistor according to positions of the gate and the active layer.

For example, a bottom-gate thin-film transistor may include a gate layer 212a on the first substrate 211, a gate insulating layer 212b on the gate layer 212a, an active layer 212c on the gate insulating layer 212b, a source-drain layer 212d on the active layer 212c, a passivation layer 212e on the source-drain layer 212d, and a pixel electrode layer 212f on the passivation layer 212e.

Refer to FIG. 2 and FIG. 3, the display panel 200 further includes a seal 230 positioned between the array substrate 210 and the color filter substrate 220, and the seal 230 is located at the periphery of the display panel 200.

Refer to FIG. 2, the display panel 200 further includes a spacer layer PS disposed between the array substrate 210 and the color filter substrate 220, and the spacer layer PS is used to adjust a cartridge pitch of the display module 100.

Refer to FIG. 2, the color filter substrate 220 may include a second substrate 221, a color resist layer 222 located at the second substrate 221, a light-shielding layer 223 in a same layer as the color resist layer 222, and a common electrode layer 224 on one side of the color resist layer 222 away from the second substrate 221, and the color resist layer 222 and the light-shielding layer 223 form the color filter layer CF, and an electric field formed by the common electrode layer 224 and the pixel electrode layer 212f drives a deflection of liquid crystal molecules in the liquid crystal layer LC within the display module 100.

Refer to FIG. 4, the light-shielding layer 223 may include a plurality of first light-shielding strips 223a and a plurality of second light-shielding strips 223b, and each of the first light-shielding strips 223a extends along an extension direction of each of the scan lines Scan, and each of the second light-shielding strips 223b extends along an extension direction of each of the data lines Data, and the plurality of first light-shielding strips 223a are arranged so as to intersect the plurality of second light-shielding strips 223b, forming a mesh structure.

In this embodiment, due to each of the data lines Data and each of the Scan lines Scan being located at a non-display area, each of the data lines Data and each of the Scan lines Scan are shielded by the light-shielding layer 223. One of the first light-shielding strips 223a is corresponded to one of the scan lines Scan, and an orthographic projection of the one of the scan lines Scan on the light-shielding layer 223 is located within the one of the first light-shielding strip 223a corresponding to the one of the scan lines Scan. One of the second light-shielding strips 223b is corresponded to one of the data lines Data, and an orthographic projection of the one of the data lines Data on the light-shielding layer 223 is located within the one of the second light-shielding strips 223b corresponding to the one of the data lines Data.

It should be noted that the data lines Data in the present application can be adaptively disposed according to a shape of the pixel electrode. For example, the scan lines Scan and the data lines Data in FIG. 4 may be horizontally and vertically crisscrossed metal lines. For other irregular-shaped pixel electrodes, the data lines Data may be parallel to the edge of the corresponding irregular-shaped pixel electrode.

Refer to FIG. 4, the color resist layer 222 includes a plurality of spaced color resist units 222a, and the plurality of color resist units 222a are embedded between the plurality of first light-shielding strips 223a and the plurality of second light-shielding strips 223b.

Refer to FIG. 4, the plurality of color resist units 222a may include a plurality of red color resists R, a plurality of green color resists G, and a plurality of blue color resists B. The red color resists R, green color resists G, and blue color resists B form a repeating unit that is arranged repeatedly in the extension direction of the scan lines Scan, and the color of the color resist units 222a in each column is the same in the extension direction of the data line Data.

It should be noted that the arrangement of each of the color resistance units 222a in FIG. 4 is merely one embodiment of the present application.

Refer to FIG. 1, the display module 100 further includes a second polarizer 400 disposed on one side of the second substrate 221 away from the array substrate 210, and a polarization axis of the first polarizer 300 is disposed perpendicularly to a polarization axis of the second polarizer 400.

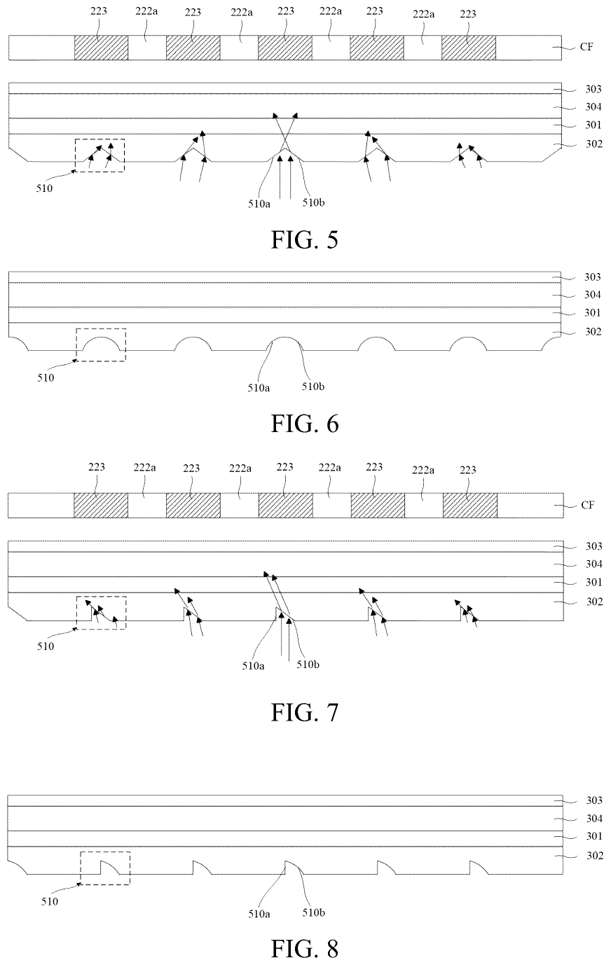

Please refer to FIG. 5, the first polarizer 300 includes a polarizing layer 301 and a first protective layer 302, and the first protective layer 302 is disposed on one side of the polarizing layer 301 away from the display panel 200, and the light adjustment structure 500 includes a plurality of grooves 510. The plurality of grooves 510 are located on one side of the first protective layer 302 away from the polarizing layer 301, and the plurality of grooves 510 are recessed towards a surface of the first protective layer 302 on one side close to the polarizing layer 301.

In this embodiment, the first polarizer 300 may further include an adhesive layer 303 disposed between the first substrate 211 and the polarizing layer 301, and a second protective layer 304 disposed between the adhesive layer 303 and the polarizing layer 301. The plurality of grooves 510 can be formed on the first protective layer 302, and the plurality of grooves 510 correspond to the plurality of first light-shielding strips 223a and/or the second light-shielding strips 223b in the light-shielding layer 223, and the plurality of grooves 510 direct the incident light ray corresponding to the light-shielding layer 223 towards the area corresponding to the color resist units 222a. Thus, without increasing the aperture ratio of the array substrate 210, the arrangement of the light adjustment structure 500 in the present application increases the number of light rays incident into the display area, thereby improving the transmittance of the display module 100 and further enhancing the display effect of the display module 100.

In this embodiment, a depth of each of the plurality of grooves 510 is less than a thickness of the first protective layer 302 so as to avoid exposing the polarizing layer 301 causing an abnormality of the polarizing layer 301.

In this embodiment, each of the grooves 510 on the first protective layer 302 has a first sidewall 510a and a second sidewall 510b, and the first sidewall 510a is a planar surface or an arc surface, and the second sidewall 510b is the planar surface or the arc surface.

In this embodiment, at least one of the first side wall 510a and the second side wall 510b directs the light rays incident to the non-photic zone NTS towards the photic zone TS.

In this embodiment, a cross-sectional figure of each of the grooves 510 in a width direction is axially symmetric. For example, in FIG. 5, the first sidewall 510a and the second sidewall 510b are the planar surface, and the cross-sectional figure is an isosceles triangle; in FIG. 6, the first sidewall 510a and the second sidewall 510b are the arc surface, and the cross-sectional figure is a semicircle or a semi-ellipse. The first sidewall 510a and the second sidewall 510b in FIG. 5 and FIG. 6 can direct the light rays incident on the non-photic zone region NTS towards the photic zone TS.

In this embodiment, the cross-sectional figure of each of the grooves 510 in a width direction is non-axially symmetric figure. For example, in FIG. 7, the first sidewall 510a and the second sidewall 510b are the planar surface, and the first sidewall 510a is perpendicular to a surface of the first protective layer 302 on one side away from the array substrate 210, and the cross-sectional figure is a right-angled triangle. For example, in FIG. 8, the first sidewall 510a is the planar surface while the second sidewall 510b is the arc surface, and the first sidewall 510a is perpendicular to a surface of the first protective layer 302 on one side away from the array substrate 210, and the cross-sectional figure is an irregular figure. The second sidewall 510b in FIG. 7 and FIG. 8 can direct the light rays incident on the non-photic zone NTS towards the photic zone TS.

Using the structures shown in FIGS. 5 and 7 as examples, the light adjustment principle of each of the grooves 510 in the present application is explained below. In the structure shown in FIG. 5, the light rays incident upon the first side wall 510a are refracted by the first side wall 510a, the light rays are directed into the display area near one side where the second side wall 510b is located. And the light rays incident upon the second side wall 510b are refracted by the second side wall 510b and directed into the display area near one side where the first side wall 510a is located. In the structure shown in FIG. 7, the light incident on the second side wall 510b is refracted by the second side wall 510b and directed into the display area near the first side wall 510a. Since the first side wall 510a is perpendicular to a surface of the first protective layer 302 on one side away from the array substrate 210, it cannot function as a light modulator.

In this embodiment, each of the grooves 510 in FIG. 5 and FIG. 7 both have an effect of light adjustment, since each of the grooves 510 in FIG. 5 can direct the light rays incident upon each of the grooves 510 into the display area on both sides of each of the grooves 510, the effect of light adjustment of the structure in FIG. 5 is superior to the effect of light adjustment of the structure in FIG. 7, referring to FIG. 6.

It should be noted that the light adjustment structure 500 in the present application is illustrated as an example merely with each of the grooves 510, and the light adjustment structure 500 can further be represented by other film layer structures with a light adjustment effect.

Due to the correspondence between the plurality of grooves 510 in the present application and the plurality of first light-shielding strips 223a and/or second light-shielding strips 223b in the light-shielding layer 223, the different positions of the plurality of grooves 510 are described below.

In this embodiment, an orthographic projection of the light adjustment structure 500 on the first substrate 211 can partially overlap an orthographic projection of the light-shielding layer 223 on the first substrate 211.

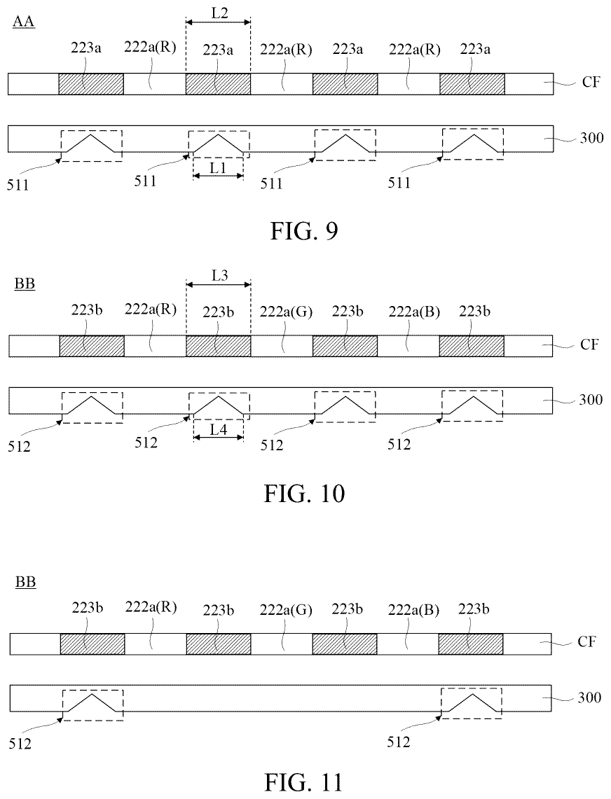

Refer to FIG. 9, the plurality of grooves 510 may include a plurality of first grooves 511, one of the first grooves 511 corresponding to the one of the first light-shielding strips 223a. An orthographic projection of the one of the first grooves 511 on the light-shielding layer 223 is located within the one of the first light-shielding strips 223a corresponding to the one of the first grooves 511.

In this embodiment, each of the first grooves 511 extends along an extension direction of each of the scan lines Scan. For example, each of the first grooves 511 may be a strip shape, alternatively, one of the first light-shielding strips 223a is arranged in correspondence with a plurality of first grooves 511 along the extension direction of each of the scan lines Scan.

In this embodiment, the orthographic projection of each of the first grooves 511 on the light-shielding layer 223 can be located within the corresponding each of the first light-shielding strips 223a. That is, a width L1 of the first groove 511 is less than or equal to a width L2 of the first light-shielding strip 223a. The width of the first light-shielding strip 223a in the present application is relatively large, that is the first light-shielding strip 223a has sufficient width to accommodate the first groove 511, so as to allow more light incident upon the first light-shielding strips 223a to be directed towards the display area. This improves the light transmittance of the display module 100, thereby enhancing the display effect of the display module 100.

In this embodiment, to improve the light adjustment effect of the light adjustment structure 500, one of the first grooves 511 of the present application is merely corresponded to one of the first light-shielding strips 223a, and a number of the first grooves 511 is equal to a number of the first light-shielding strips 223a.

In this embodiment, due to the effect of resistance-capacitance of the display module 100, the brightness in areas away from the signal emitting terminal is lower than the brightness in areas close to the signal emitting terminal. Therefore, the light adjustment structure 500 can be merely disposed in the area away from the signal output terminal, that is the number of first grooves 511 may be less than the number of first light-shielding strips 223a, so as to improve the issue of uneven brightness in different areas of the display module 100.

Refer to FIG. 10, the light adjustment structure 500 includes a plurality of second grooves 512, one of the second grooves 512 corresponds to one of the second light-shielding strips 223b, and an orthographic projection of the one of the second grooves 512 on the shielding layer 223 partially overlaps the one of the first light-shielding strip 223a corresponding to the second grooves.

In this embodiment, the second groove 512 extends along the extension direction of the data lines Data. For example, the second groove 512 may be a strip shape, alternatively, in the extension direction of the data lines Data, one of the second light-shielding strips 223b is correspondingly arranged with a plurality of second grooves 512.

In this embodiment, as the width L2 of the first light-shielding strip 223a is greater than a width L3 of the second light-shielding strip 223b, to prevent the second groove 512 from overlapping the adjacent color resist units 222a, a width L4 of second groove 512 can be reduced so as to enable the orthographic projection of the second groove 512 on the light-shielding layer 223 to be located within the corresponding second light-shielding strips 223b. That is, the width L4 of the second groove 512 can be less than or equal to a width L3 of each of the second light-shielding strips 223b, and the width L4 of each of the second grooves 512 is less than the width L1 of each of the first grooves 511.

In this embodiment, that is, in an extension direction of the scan lines Scan, at least one of the color resist units 222a is disposed at intervals the between two adjacent second grooves 512. For example, please refer to FIG. 10, the number of second grooves 512 can be the same as the number of second light-shielding strips 223b, namely each second groove 512 corresponds to a second light-shielding strip 223b, and at least one of the color resist units 222a is disposed at intervals between two adjacent second grooves 512.

Alternatively, refer to FIG. 11, the number of second grooves 512 may be less than the number of second light-shielding strips 223b. For example, in the extension direction of the scan lines Scan, three of the color resist units 222a are disposed at intervals between the two adjacent second grooves 512.

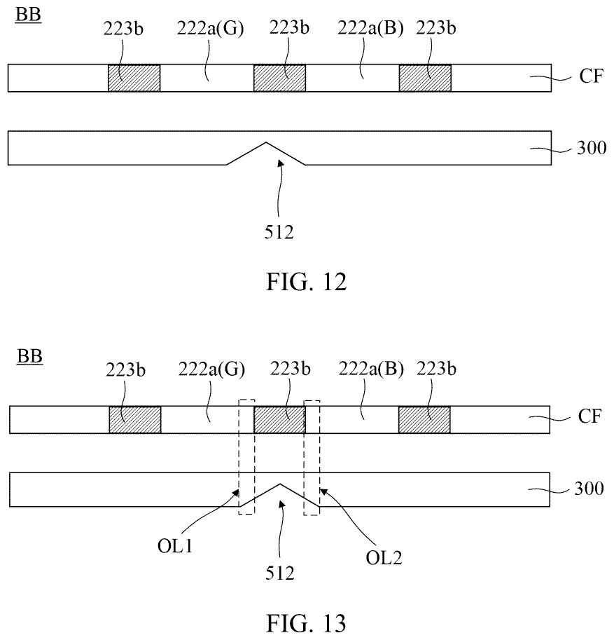

In this embodiment, the width of the second groove 512 of the present application may further be greater than the width of the second light-shielding strip 223b, namely the second groove 512 overlaps the corresponding second light-shielding strip 223b and extends towards the display area. For example, in the extension direction of the scan lines Scan, the second grooves 512 partially overlaps at least one of the two adjacent color resist units 222a; refer to FIG. 12, where each of the second grooves 512 partially overlaps one adjacent color filter unit 222a; refer to FIG. 13, where each of the second grooves 512 may have an overlapping section with the two adjacent color resist units 222a.

In the structure shown in FIG. 13, the second groove 512 and the green color resist G have a first overlapping section OL₁, and the second groove 512 and the blue color resist B have a second overlapping section OL₂. Since the incident light corresponding to the first overlapping section OL₁ is directed into the blue color resist B, and the incident light corresponding to the second overlapping section OL₂ is directed into the green color resist G, and the incident light corresponding to the second light-shielding strip 223b is compensated into the green color resist G and the blue color resist B, the technical proposal of the present application can ensure the brightness uniformity of the display module 100, even if each of the second grooves 512 overlaps the adjacent each of color resist units 222a. Additionally, increasing the width of each of the second grooves 512 reduces manufacturing difficulty and lowers the cost of the display module 100.

It should be noted that the light adjustment structure 500 of the present application may simultaneously include the plurality of first grooves 511 and the plurality of second grooves 512. Each of the first grooves 511 corresponds to each of the first light-shielding strips 223a, and each of the second grooves 512 corresponds to each of the second light-shielding strips 223b. The specific structure can refer to the embodiments as described above, and will not be repeated here.

The present application further provides a display device, and the display device includes the display module as described above. In this embodiment, the display device could be any of the following products or parts with a display function: mobile phone, tablet computer, television, monitor, laptop computer, digital photo frame, navigator, or the like.

In the description of the present application, the terms “first” and “second” are used solely for descriptive purposes and should not be understood to imply relative importance or implicitly specify the number of technical features indicated. Thereby, a feature defined as “first” or “second” may include one or more features explicitly or implicitly. In the description of the present application, “a plurality” means two or more, and “at least one” means one, two, or more, unless otherwise specifically defined.

In the above embodiments, each embodiment focuses on various aspects. For parts not described in detail in an embodiment, please refer to the relevant descriptions of other embodiments.

In the present application, the embodiments, implementation methods, and related technical features can be combined and substituted with each other without conflict.

The above is merely a preferred embodiment of the present application and does not impose any form of limitation on it. Any simple modifications, equivalent changes, and embellishments made to the above embodiment based on the technical essence of this application, without deviating from the content of the technical proposal of this application, shall still fall within the scope of the technical proposal of this application.

What is claimed is:

1. A display module, comprising:
a display panel, comprising a first substrate, a light-shielding layer along with a plurality of date lines and a plurality of scan lines located at the first substrate, and orthographic projections of the plurality of data lines and the plurality of scan lines on the first substrate being located within an orthographic projection of the light-shielding layer on the first substrate; and
a first polarizer, disposed on one side of the first substrate away from a light-exiting surface of the display panel, and a light adjustment structure being disposed on the first polarizer, and the light adjustment structure corresponding to the light-shielding layer;
wherein the display module comprises a photic zone and a non-photic zone, and the non-photic zone corresponds to the light-shielding layer, and the light adjustment structure is configured to direct light incident on the non-photic zone towards the photic zone.

2. The display module according to claim 1, wherein the first polarizer comprises a polarizing layer and a first protective layer disposed on one side of the polarizing layer away from the display panel;
wherein the light adjustment structure comprises a plurality of grooves, and the plurality of grooves are disposed on one side of the first protective layer away from the polarizing layer, and the plurality of grooves are recessed towards a surface of the first protective layer on one side close to the polarizing layer.

3. The display module according to claim 2, wherein each of the grooves on the first protective layer has a first sidewall and a second sidewall arranged at an angle to each other, wherein the first sidewall is a planar surface or an arc surface, and the second sidewall is the planar surface or the arc surface;
wherein at least one of the first sidewall and the second sidewall directs a light incident to the non-photic zone towards the photic zone.

4. The display module according to claim 3, wherein a cross-sectional figure of each of the grooves on a reference plane is an axially symmetric figure, and the cross-sectional figure is an isosceles triangle, a semicircle, or a semi-ellipse, and the reference plane is parallel to the first substrate.

5. The display module according to claim 3, wherein a cross-sectional figure of each of the grooves on a reference plane is a non-axially symmetric figure, the cross-sectional figure is a right-angled triangle, and the reference plane is parallel to the first substrate.

6. The display module according to claim 1, wherein an orthographic projection of the light adjustment structure on the first substrate partially overlaps an orthographic projection of the light-shielding layer on the first substrate.

7. The display module according to claim 6, wherein the light-shielding layer comprises a plurality of first light-shielding strips, and one of the first light-shielding strips is corresponded to one of the scan lines, and an orthographic projection of the one of the scan lines on the light-shielding layer is located within the one of the first light-shielding strips corresponding to the one of the scan lines;
wherein the light adjustment structure comprises a plurality of first grooves, and one of the first grooves is corresponded to one of the first light-shielding strips, and an orthographic projection of the one of the first grooves on the light-shielding layer is located within the one of the first light-shielding strips corresponding to the one of the grooves.

8. The display module according to claim 7, wherein the first groove extends along an extension direction of each of the scan lines, and a width of the first groove is smaller than or equal to a width of the first light-shielding strip.

9. The display module according to claim 7, wherein one of the first grooves is merely corresponded to one of the first light-shielding strips, and a number of the first grooves is less than or equal to a number of the light-shielding strips.

10. The display module according to claim 6, wherein the light-shielding layer comprises a plurality of second light-shielding strips, one of the second light-shielding strips is corresponded to one of the data lines, and an orthographic projection of the one of the data lines on the light-shielding layer is located within the one of the second light-shielding strips corresponding to the one of the second light-shielding strips;
wherein the light adjustment structure comprises a plurality of second grooves, and one of the second grooves is corresponded to one of the light-shielding strips, and an orthographic projection of the one of the second grooves on the light-shielding layer partially overlaps the one of the second light-shielding strips corresponding to the one of the second grooves.

11. The display module according to claim 10, wherein the second groove extends along an extension direction of the data lines, and a width of the second groove is greater than a width of the second light-shielding strip.

12. The display module according to claim 11, wherein the display panel further comprises a color resist layer disposed at a same layer as the light-shielding layer, and the color resist layer comprises a plurality of color resist units embedded within the light-shielding layer;
wherein, in an extension direction of the scan lines, at least one of the color resist units is disposed at intervals between two adjacent second grooves.

13. The display module according to claim 12, wherein, in the extension direction of the scan lines, each of the second grooves overlaps at least one of the two adjacent color resist units.

14. The display module according to claim 13, wherein the plurality of color resist units comprise a plurality of red color resists, a plurality of green color resists, and a plurality of blue color resists, and in the extension direction of the scan lines, three of the color resist units are disposed at intervals between the two adjacent second grooves, and the second groove has an overlapping section with an adjacent green color resist and an adjacent blue color resist.

15. The display module according to claim 2, wherein an orthographic projection of the light adjustment structure on the first substrate partially overlaps an orthographic projection of the light-shielding layer on the first substrate.

16. The display module according to claim 3, wherein an orthographic projection of the light adjustment structure on the first substrate partially overlaps an orthographic projection of the light-shielding layer on the first substrate.

17. The display module according to claim 4, wherein an orthographic projection of the light adjustment structure on the first substrate partially overlaps an orthographic projection of the light-shielding layer on the first substrate.

18. The display module according to claim 5, wherein an orthographic projection of the light adjustment structure on the first substrate partially overlaps an orthographic projection of the light-shielding layer on the first substrate.

19. A display device comprising the display module, wherein the display module comprises:
a display panel, comprising a first substrate, a light-shielding layer along with a plurality of date lines and a plurality of scan lines located at the first substrate, and orthographic projections of the plurality of data lines and the plurality of scan lines on the first substrate being located within an orthographic projection of the light-shielding layer on the first substrate; and
a first polarizer, disposed on one side of the first substrate away from a light-exiting surface of the display panel, and a light adjustment structure being disposed on the first polarizer, and the light adjustment structure corresponding to the light-shielding layer;
wherein the display module comprises a photic zone and a non-photic zone, and the non-photic zone corresponds to the light-shielding layer, and the light adjustment structure is configured to direct light incident on the non-photic zone towards the photic zone.

20. The display device according to claim 19, wherein the first polarizer comprises a polarizing layer and a first protective layer disposed on one side of the polarizing layer away from the display panel;
wherein the light adjustment structure comprises a plurality of grooves, and the plurality of grooves are disposed on one side of the first protective layer away from the polarizing layer, and the plurality of grooves are recessed towards a surface of the first protective layer on one side close to the polarizing layer.
